(19) United States
(12) Patent Application Publication
(10) Pub. No.: US 2016/0349797 A1
(43) Pub. Date: Dec. 1, 2016

(54) SYSTEM, APPARATUS, AND METHOD FOR IMPLEMENTING A TOUCH INTERFACE ON A WEARABLE DEVICE

(71) Applicants: Vikram Malhotra, Portland, OR (US); Alexander Schoenen, Beaverton, OR (US)

(72) Inventors: Vikram Malhotra, Portland, OR (US); Alexander Schoenen, Beaverton, OR (US)

(21) Appl. No.: 14/724,534

(22) Filed: May 28, 2015

(51) Int. Cl. G06F 1/16; G06F 3/041; G06F 1/32; G06F 3/044

(52) U.S. Cl. CPC G06F 1/1643; G06F 1/163; G06F 1/169; G06F 3/044; G06F 3/0412; G06F 1/3215; G06F 1/3262; G06F 1/1684; G06F 1/1601; G06F 2203/04103

(57) ABSTRACT

The present disclosure is directed to apparatuses, systems, and methods for implementing a touch interface on a wearable computing device. Described herein is a wearable computing device comprising a printed circuit board (PCB), a housing configured to be attached to a user, enclosed over the PCB, and including a display surface, a plurality of electronic components disposed on the PCB and including a plurality of display components to generate display data visible through the display surface of the housing, and a user input touch interface at least partially overlapping the display surface of the housing. The user touch interface includes an array of capacitive touch sensitive electrode elements disposed on the PCB, wherein at least some of the electrode elements are interspersed on the PCB between two or more of the display components, and sensing circuitry configured to detect changes in the array of capacitive touch sensitive electrode elements.

### TECHNICAL FIELD

The present application relates generally to the technical field of mobile computing devices and, in particular, to display and user touch interfaces for wearable mobile computing devices.

### BACKGROUND

Wearable mobile computing devices are used for a variety of applications, including user activity monitoring and biometric sensor data accumulation, and can also be communicatively coupled to a primary, non-wearable device (e.g., a smartwatch communicatively coupled to a smartphone).

Wearable mobile computing device housings can be designed to provide impact protection, to limit water ingress, and/or to be pliable to conform to different users (e.g., for wearable devices including biometric sensors, housings can be designed to ensure these sensors are to come in contact with potentially different users). Prior art mobile computing device display and user touch interfaces, such as touchscreens, typically require a hard, flat glass or plastic surface to display data and to accept user touch input; these solutions are susceptible to damage from impact, do not limit water ingress, and are not pliable.

### BRIEF DESCRIPTION OF THE DRAWINGS

The following description includes discussions of figures having illustrations given by way of example of implementations and embodiments of the subject matter disclosed herein. The drawings should be understood by way of example, and not by way of limitation. As used herein, references to one or more “embodiments” are to be understood as describing a particular feature, structure, or characteristic included in at least one implementation of the disclosure. Thus, phrases such as “in one embodiment” or “in an alternate embodiment” appearing herein describe various embodiments and implementations of the disclosure, and do not necessarily all refer to the same embodiment. However, such phrases are also not necessarily mutually exclusive.

FIG. 1 is an illustration of a wearable mobile computing device in accordance with some embodiments.

FIG. 2A-FIG. 2C are illustrations of portions of a wearable computing device in accordance with some embodiments.

FIG. 3 is a flow diagram of a method for operating an electrode array for a user touch interface of a wearable computing device in accordance with some embodiments.

FIG. 4A-FIG. 4C are illustrations of user interactions with a user display and touch interface in accordance with some embodiments.

FIG. 5 is a flow diagram of a method for creating a user touch interface of a wearable computing device in accordance with some embodiments.

FIG. 6 is a block diagram illustrating components of a machine, according to some example embodiments, able to read instructions from a machine-readable medium and perform any one or more of the methodologies discussed herein, in accordance with some embodiments.

Descriptions of certain details and implementations follow, including a description of the figures, which can depict some or all of the embodiments described below, as well as a description of other potential embodiments or implementations of the concepts presented herein. An overview of embodiments is provided below, followed by a more detailed description with reference to the drawings.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the disclosure can be practiced without these specific details. In general, well-known instruction instances, protocols, structures, and techniques have not been shown in detail.

Throughout this specification, several terms of art are used. These terms are to take on their ordinary meaning in the art from which they come, unless specifically defined herein or unless the context of their use would clearly suggest otherwise. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects of the disclosure.

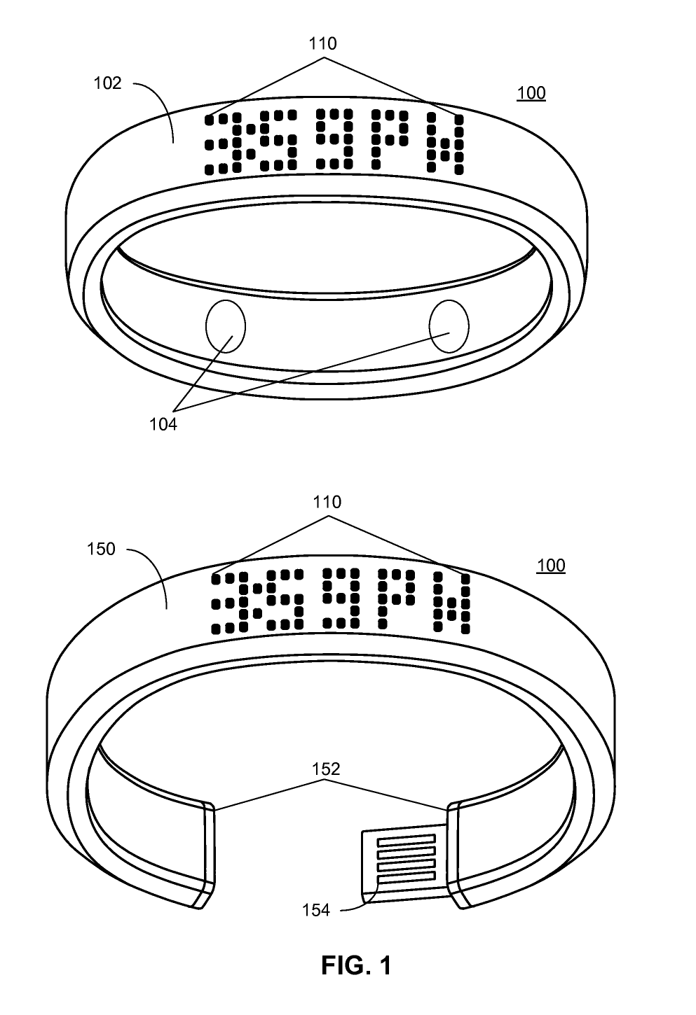

FIG. 1 is an illustration of a wearable mobile computing device 100 in accordance with some embodiments. The device 100 is shown to include a wearable housing 102 configured for wearing on a wrist of a user. Other example embodiments can utilize housings for wearing on different user body parts. The wearable housing 102 is shown to comprise a flexible continuous band for wearing on the wrist of the user; for example, the wearable housing 102 can be formed from a silicone and/or rubber compound, a thermoplastic polyurethane (TPU) material, etc. An alternative example housing for the device 100 is shown as housing 150, which is shown to include a clasp 152 for securing the housing 150 on the user (the clasp 152 is illustrated in the open position, and is closed to secure the housing 150). In some embodiments, an input/output (I/O) interface 154, such as a Universal Serial Bus (USB) interface, a Thunderbolt interface, etc., can be concealed by the clasp 152 in the closed position.

The device 100 can be used to monitor movements/activities of the user. The housing 102 for the device 100 is further shown to include biometric sensors 104 used to collect biometric data from the user. The biometric sensors 104 can comprise any sensor capable of detecting metric data such as pulse/heart rate, blood pressure, body temperature, etc. The device 100 can include additional sensor assemblies (not shown) to generate motion sensor data (e.g., via an accelerometer, gyroscope, etc.) Any combination of this sensor data can be tracked to determine the user's activity level, and/or can be used to identify a user's activity. For example, logic and/or modules can be executed via one or more processing units (described in further detail below) included in the device 100 to compare a sensor signal to one or more signal or activity “templates” or “signatures.” Detected movements or parameters determined from the collected sensor data can include (or be used to form) a variety of different parameters, metrics or physiological characteristics including but not limited to speed, distance, steps taken, and energy expenditure such as calories, heart rate, sweat detection, effort, oxygen consumed, oxygen kinetics, etc.

A user display and touch interface 110 is shown to be disposed opposite the biometric sensors 104 in the housing 102, and opposite the clasp 152 of the housing 150. The user display and touch interface 110 can comprise an illuminable portion of the device 100 to display data on a display surface such as device settings, time data (as shown in this illustration), location data, activity data, etc.

In this embodiment, the wearable housing 102/150 of the device 100 is shown to be curved for wearing on a wrist of the user (the shape of the wearable housing 102/150 can be similar if intended to be worn on an arm, ankle, etc.), and thus, the display surface of the device 100 is similarly curved. The wearable housing 102/150 is shown to be curved along multiple axes; thus, implementing a traditional flat, rigid display surface is not feasible for this housing 102/150. The user display and touch interface 110 is shown to comprise a plurality of illuminable display components, such as light emitting diodes (LEDs) disposed to conform to the surface of the wearable housing 102/150.

In the embodiment, the display data is visible through the wearable housing 102/150. In some embodiments, the wearable housing 102/150 comprises an at least semi-transparent material. In some embodiments, the wearable housing 102/150 comprises a semi-opaque material, and the housing portion over the plurality of illuminable display components is thinned (i.e., has a reduced thickness compared to surrounding portions of the housing 102/150) to allow the display data to be visible through the wearable housing 102/150.

Accepting user touch input via the user display and touch interface 110 provides a more direct and robust interaction with the data displayed. Furthermore, accepting user input via the user display and touch interface 110 allows for the elimination of a mechanical input mechanism, such as a depressible input button, and thereby eliminating deficiencies of such mechanisms, such as mechanical failure, water ingress, protruding structures susceptible to impact damage, etc.

Due to the shape of the illuminable display, current touch interface solutions, such as glass or plastic touchscreens, could not be utilized by the device 100, as these solutions utilize a flat, non-pliable surface for receiving user touch input. As described in further detail below, embodiments of the disclosure can utilize any combination of capacitive touch electrode configurations and sensing circuitry/modules to implement a touch interface in a wearable device.

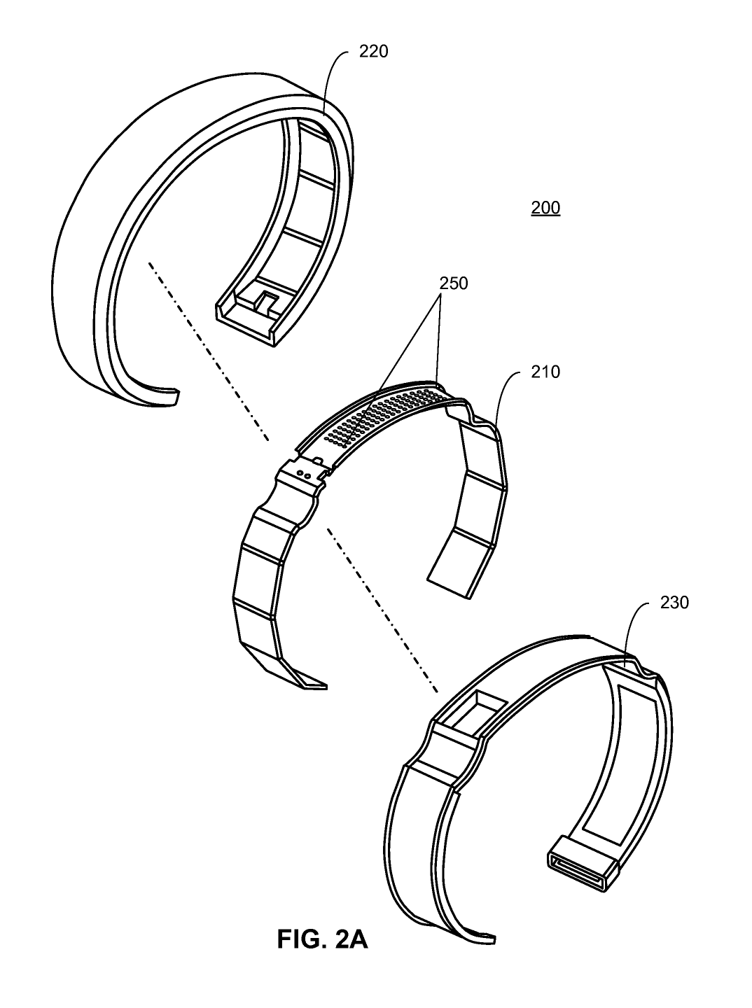

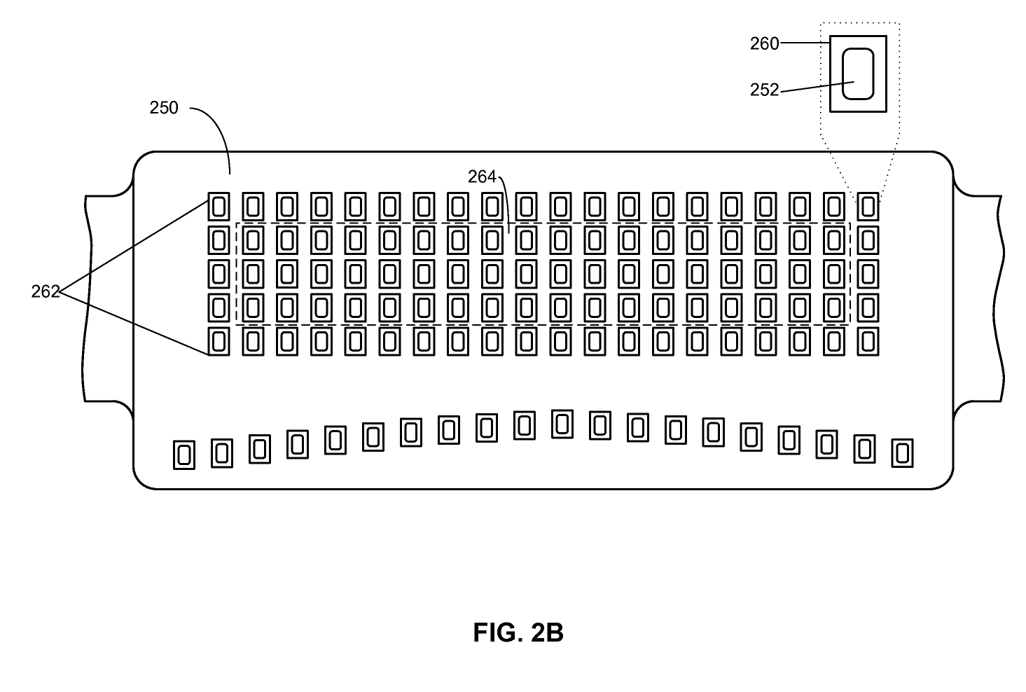

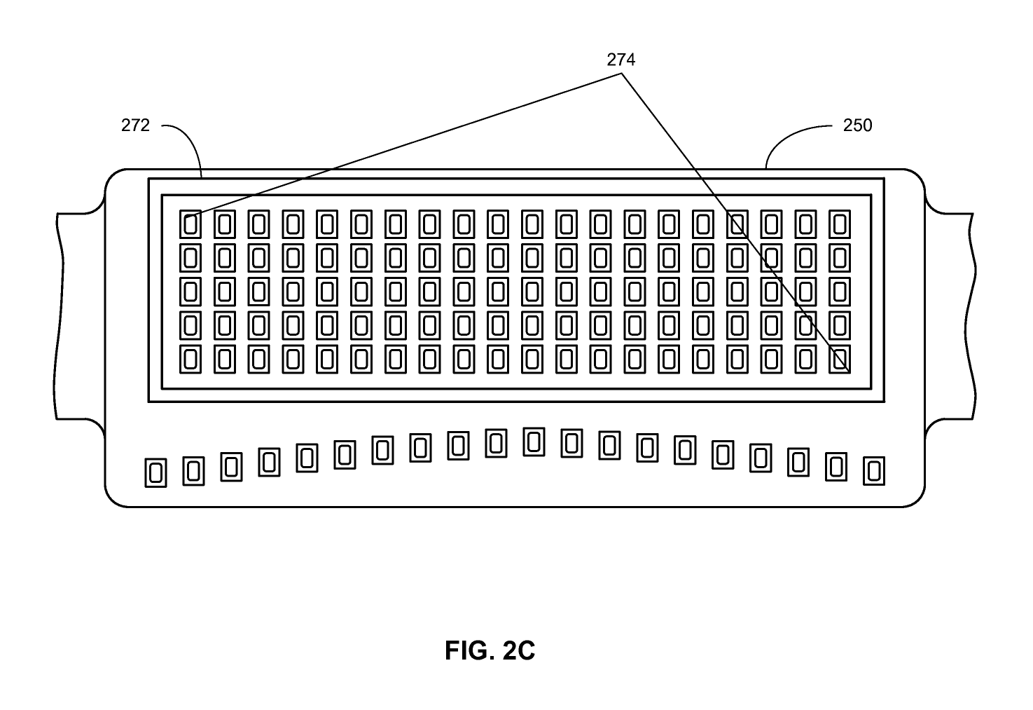

FIG. 2A-FIG. 2C are illustrations of portions of a wearable computing device in accordance with some embodiments. FIG. 2A is an illustration of an exploded view of a wearable computing device in accordance with some embodiments. In this embodiment, a wearable computing device 200 is shown to include a flexible circuit member 210, which can comprise a flexible PCB, a flexible printed circuit (FPC), etc. The flexible circuit member 210 can include memory, processing units, power delivery management circuits, the sensors described above, and the illuminable display components described above.

The wearable computing device 200 is further shown to include an overmold portion 220 and a spine support member 230. The overmold portion 220 is configured to be attached to a user and is to enclose the flexible circuit member 210. The flexible circuit member 210 is flexible enough to wrap around the spine support member 230 of the device 200, and also robust enough to survive the overmold process to create the overmold portion 220 (i.e., the overmold portion 220 is molded/cured over the flexible circuit member 210) and any subsequent flexing during use by a user. The flexible circuit member 210 is shown to include, in addition to the electronic components described above, a display and user touch interface circuitry 250, described in further detail below.

FIG. 2B is an illustration of electronic components including an array of illuminable components and an array of touch sense electrodes for the flexible circuit member 210 in accordance with some embodiments. The display and user touch interface circuitry 250 is shown to include an array of illuminable components (including an illuminable component 252), which are shown in this example to comprise LEDs. In other embodiments, other illuminable components can be utilized, such as display components utilizing a separate light source for illuminable components (e.g., a laser source with its beam diffused by a diffuser, ElectroLuminescence (EL), an Electrophoretic Display (EPD), etc.).

Touch interface capabilities for the circuitry 250 are via an electrode array (including electrode 260) and a capacitive touch controller (not shown). In some embodiments, the electrode array and the array of illuminable components are disposed on a same surface (e.g., top surface) of the flexible circuit member 210. As shown in this illustration, the electrode array is interleaved (i.e., interspersed, disposed between) the electronics of the flexible circuit member 210, including the array of illuminable components; in this example, the electrodes (e.g., the electrode 260) are each shown to surround the illuminable component 252 (e.g., an LED). Having the electrode array interleaved between the electronic components of the display and user touch interface circuitry 250 allows for display and touch interface surface to be created without the use of glass, hard plastic, or conductive films. The footprint of the circuitry 250 is also reduced by interleaving the electrodes between the PCB electronic components (and thus, in some embodiments, under the display surface of the overmold housing 220) rather than placing the electrodes in a dedicated area away from the electronic components. Furthermore, creating the electrodes directly out of copper on a PCB rather than as a separate film layer reduces the costs of manufacturing the device 200, and allows the entire flexible circuit member 210 to be overmoldable (in some embodiments, the flexible circuit member 210 receives power from a battery supply that is connected subsequent to the overmolding process).

In some embodiments, power management logic/modules can be executed to dynamically adjust the rate at which the electrodes of the electrode array are scanned to maximize battery life. In this embodiment, the electrode array is shown to comprise a first subset of electrodes 262 (i.e., the electrodes outside the center dashed box) and a second set of electrodes 264 (i.e., the electrodes within the center dashed box). In some embodiments, the first subset of electrodes 262 are operable during a low-power mode, and the second subset of electrodes 264 disabled during the low-power mode. This configuration can be utilized if a coarser, less responsive touch detection process is to be utilized to detect an expected gesture to transition the device 200 from a low-power mode to an operational mode (e.g., a swipe across the display and user touch interface circuitry 250), and to not detect unexpected gestures (e.g., quick taps on across the display and user touch interface circuitry 250). The first subset of electrodes 262 and the second subset of electrodes 264 can be operable during an operating mode different than the low-power mode to provide a more responsive, touch-sensitive interface.

FIG. 2C is an illustration of an alternative to an electrode array configuration for the flexible circuit member 210, in accordance with some embodiments. In this example, a set of electrodes is shown to include a larger electrode 272 surrounding an array of electrodes 274. The larger electrode 272 provides a coarser, less responsive touch detection process to be utilized to detect a gesture (e.g., a large, continuous swipe across the display and user touch interface circuitry 250) to transition the device 200 from a low-power mode to an operational mode. In this example, the larger electrode 272 is disabled and the array of electrodes 274 is enabled during an operating mode different than the low-power mode to provide a more responsive, touch-sensitive interface.

Thus, for the electrode configurations described above, controller modules/logic can dynamically activate/deactivate some of the electrodes to better manage overall power consumption of a wearable mobile computing device 200. For example, when the touch interface is not actively in use, certain electrodes or zones of the electrode array can be selectively powered down, set to scan at a lower rate, or set to scan at a lower fidelity in order to limit battery usage. However, when a user input is detected, more or different electrodes zones can be activated at higher scan rates in order to optimize the responsiveness of the interface to user inputs.

Other subset formations different that those discussed above can be utilized in other embodiments. Furthermore, in some embodiments, different subsets of electrodes can be enabled/disabled depending on the application executed via the wearable mobile computing device 200 to better manage overall power consumption of a wearable mobile computing device. As described in further detail below, subsets of electrodes can be enabled/disabled based on the types of gestures expected for an application, icons to be displayed for an application, etc.

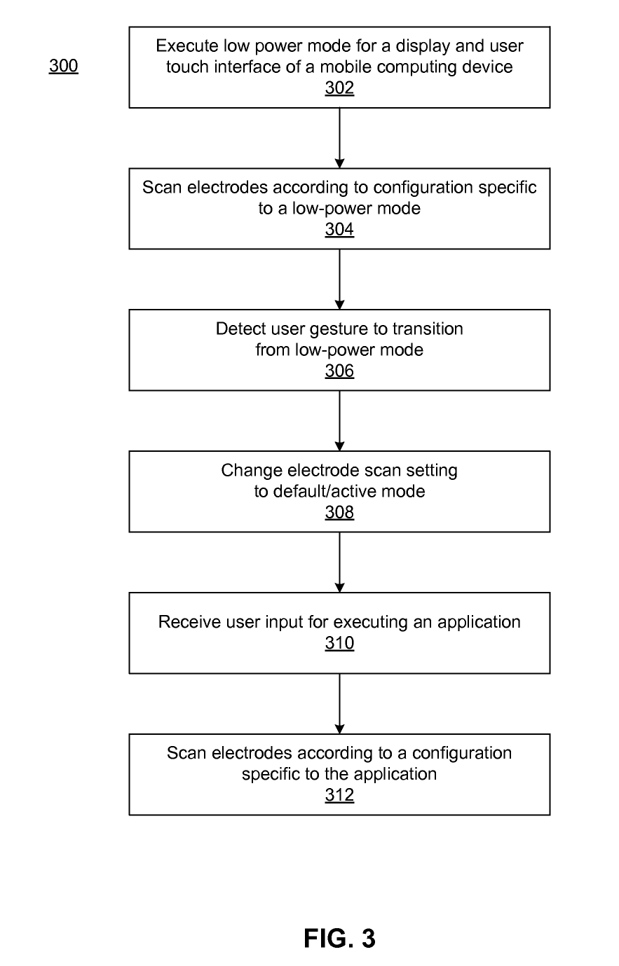

FIG. 3 is a flow diagram of a method for operating an electrode array for a user touch interface of a wearable computing device in accordance with some embodiments. Process and logical flow diagrams as illustrated herein provide examples of sequences of various process actions. Although shown in a particular sequence or order, unless otherwise specified, the order of the actions can be modified. Thus, the described and illustrated implementations should be understood only as examples, and the illustrated processes can be performed in a different order, and some actions can be performed in parallel. Additionally, one or more actions can be omitted in various embodiments; thus, not all actions are executed in every implementation. Other process flows are possible.

A process 300 is illustrated to identify when touch events occur and dynamically manage how an electrode array of a display and user touch interface is powered on and/or scanned to maximize battery life. The process 300 is shown to include executing an operation for a mobile computing device to execute a low power mode for a display and user touch interface (shown as block 302). The low power mode can be executed in response to detecting user inactivity (e.g., a lack of motion data captured via one or more motion sensors, a lack of detected user touch inputs), detecting the device is not being worn by the user (e.g., a lack of biometric data captured via one or more biometric sensors), the user manually setting the device to a low-power mode, etc.

An operation is executed to scan the electrodes of the display and user touch interface of the mobile computing device according to a configuration specific to the low power mode (block 304). In some embodiments, a subset of electrodes (comprising a quantity smaller than the total number of electrodes) are scanned during the low power mode. In some embodiments, the wearable mobile computing device includes a subset of electrodes that are used specifically during the low power mode (e.g., the electrode 272 of FIG. 2C).

An operation is executed to detect a user gesture to transition from low power mode (block 306). Scanning fewer electrodes and/or reducing the scan rate of the electrodes can prevent detecting a quick user contact with the device that was not intended to transition the device from the low power mode. An operation is executed to change the electrode scan settings to a default or active mode (shown as block 308); this can include enabling all electrodes to be scanned, disabling electrodes used specifically for the low power mode, and/or increasing the scan rate of the electrodes.

An operation is detected to receive a user input for executing an application (shown as block 310). This can include the user providing touch input via the user touch interface to execute a specific application. In some embodiments, user activity can be detected and an application can be executed in response to detecting specific user activity (e.g., motion sensor data can be compared to signal or activity “templates” or “signatures” to determine that a user is performing an activity having a corresponding application executed via the wearable mobile computing device). An operation is executed to scan the electrodes according to a configuration specific to the application (shown as block 312). For example, the sensitivity of the electrodes can be decreased if the expected user activity has an increased likelihood of light contact on the touch interface (i.e., the electrode scan rate is decreased to reduce the likelihood of detecting false user touch inputs). In another example, the electrodes can be configured to detect a subset of possible user touch gestures (e.g., detecting long swipes or double-taps only to reduce the likelihood of detecting false user touch inputs). In other embodiments, the sensitivity of the user touch interface can be increased by increasing the scan rate and/or increasing the number of electrodes to be scanned. Increasing the sensitivity of the user touch interface can enable, for example, swipe gestures of various speeds to be detected. Increasing the sensitivity of the user touch interface can also provide a pressure-sensitive user touch interface; for example, a user gesture comprising a hard press onto the user touch interface may activate more electrodes as the fingertip of the user is being squeezed flatter and wider. This implementation would enable a third axis for the user touch interface so that it is reactive to touch gestures in the X, Y, and Z axes.

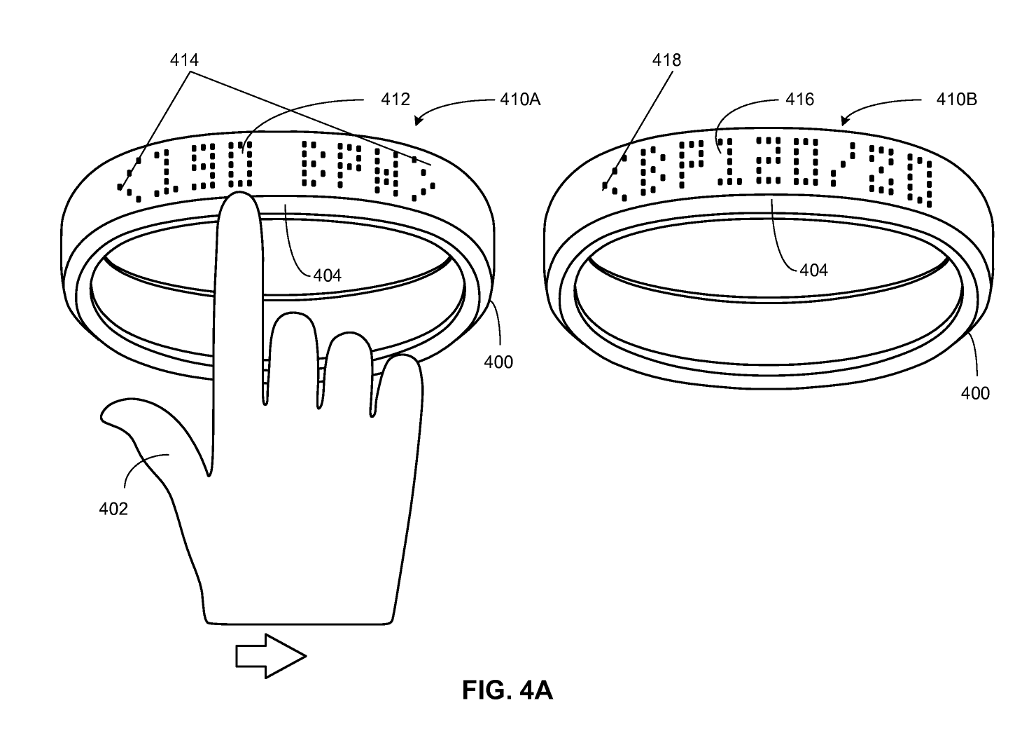

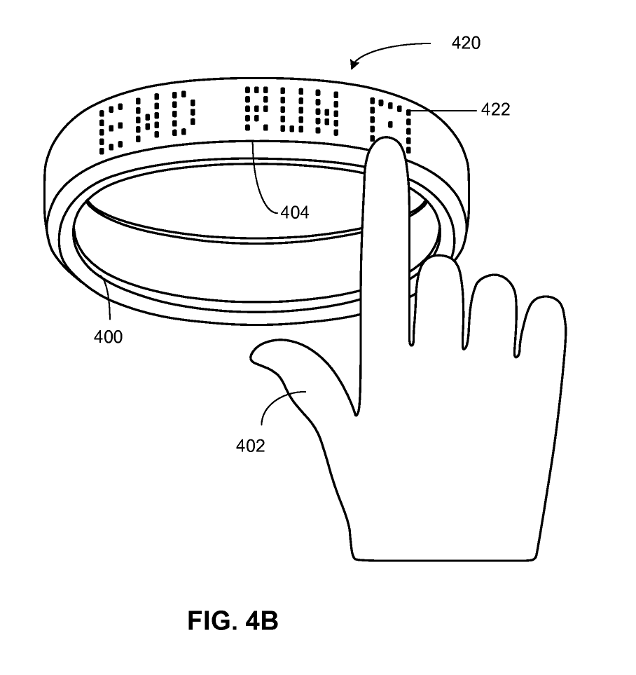

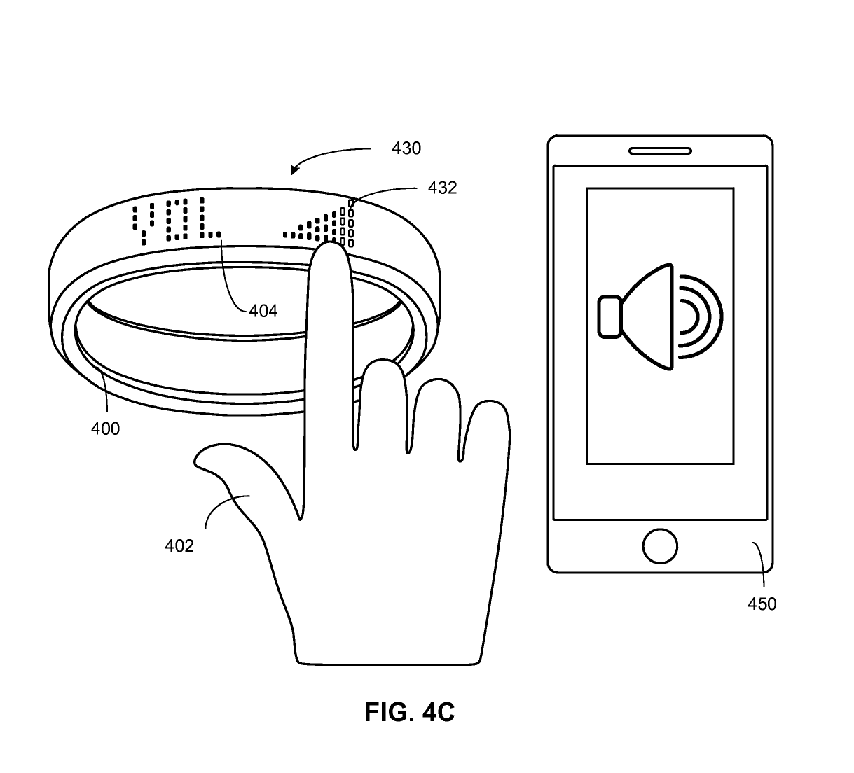

FIG. 4A-FIG. 4C are illustrations of user interactions with a user display and touch interface in accordance with some embodiments. FIG. 4A illustrates a wearable computing device 400 used by a user 402 (the device 400 is illustrated as being unworn for the clarity of the illustration). The wearable computing device 400 is shown to include a user display and touch interface 404 displaying display data 410. In this example, an application to detect the biometric data of the user 402 during a physical exercise is executed by the wearable computing device 400, and the display data 410A comprises biometric data of the user 402. In this example, the display data 410A is shown as a heart rate 412 of the user 402, and is further shown to include arrows 414 to indicate that the user 402 can swipe left or right for the user display and touch interface 404 to display additional biometric data. In this example, the user 402 is shown to swipe right so that the display data 410B, comprising blood pressure data 416 of the user 402, is displayed. A single arrow 418 is displayed to indicate to the user 402 that to review additional biometric data, the user 402 is to swipe to the left.

Because the expected gestures from the user 402 are left/right swipes, the granularity of detected user touch inputs can be reduced to eliminate the detection on non-swipe gestures (e.g., taps). The granularity of detected user touch inputs can be reduced by enabling a reduced subset and/or specific electrodes of the user display and touch interface 404, by adjusting the scan rate of the electrodes, etc. In other embodiments, the granularity of detected user touch inputs can be increased to allow for swipe gestures of various speeds to be detected—for example, the speed of the transition from display data 410A to display data 410B can increase according to the speed of the swipe gesture.

FIG. 4B illustrates the wearable computing device 400 shown to include a user display and touch interface 404 displaying display data 420. In this example, the user 402 is using the wearable mobile computing device 400 while engaging in a running activity. The wearable mobile computing device 400 detects sensor data indicating that the user 402 has ended her run—e.g., motion data from an accelerometer or a gyroscope indicating the user 402 is standing still, location data such as Global Positioning Satellite (GPS) data indicating that the user 402 is not moving from her current position, etc. The display data 420 is shown to display a request for the user 402 to confirm that she has ended her run by inputting a prolonged touch gesture on the displayed icon 422. Thus, during this portion of the executed application, a prolonged touch interface is to be expected only on the displayed icon 422, and thus, sensing electrodes outside of the displayed icon 422 can be disabled, and the scan rate of the electrodes within the displayed icon 422 can be reduced as quick touch gestures are to be ignored.

FIG. 4C illustrates the wearable computing device 400 shown to include the user display and touch interface 404 displaying display data 430. In this embodiment, the wearable computing device 400 is shown to be communicatively coupled to a second mobile computing device 450 via a wireless network connection. In this example, the second mobile computing device 450 is executing an audio application, and the user display and touch interface 404 is shown to display a control icon 432 for controlling the audio output of the second mobile computing device 450. Thus, in this example the display and user touch interface 404 provides the user 402 with a secondary control mechanism for the second mobile computing device 450.

In some embodiments, the scan rate of the electrodes of the display and touch interface 404 and/or specific subsets of the electrodes of the display and touch interface 404 may be configured according to an application executed via the second mobile computing device 450, similar to the operations described with respect to block 312 of FIG. 3. For example, the scan rate of electrodes and/or the number of electrodes scanned may be increased to allow for varying speeds of user gestures on the display and touch interface 404 to control the application executed via the second mobile computing device 450 accordingly (e.g., fast/slow swipes on the display and touch interface 404 to scroll through display data of the second mobile computing device 450).

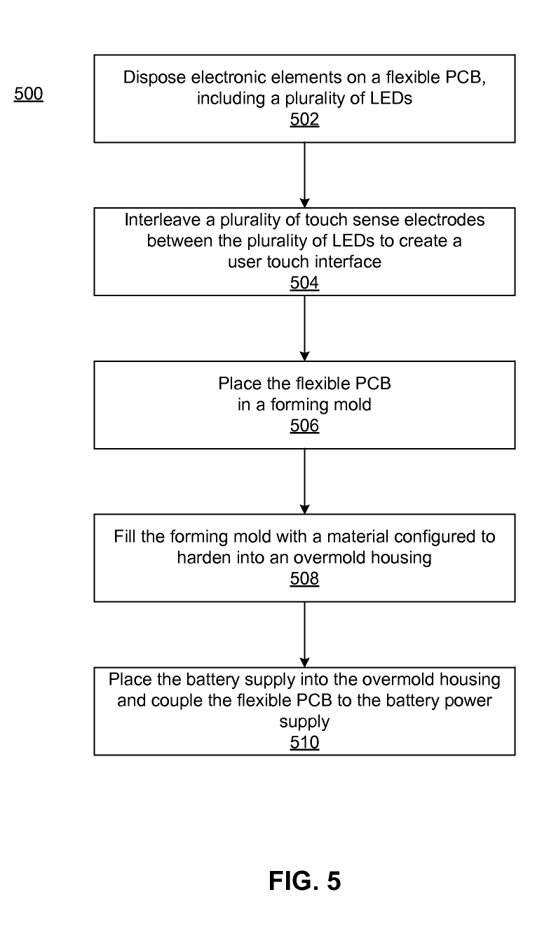

FIG. 5 is a flow diagram of a method for creating a user touch interface of a wearable computing device in accordance with some embodiments. A process 500 is shown to include executing an operation to dispose a plurality of electronic elements on a flexible PCB, including a plurality of LEDs to create a display area (shown as block 502). The flexible PCB can comprise a plastic substrate (for example, a high molecular film) that can be changed by external pressure. The plastic substrate can include a barrier coating on both surfaces on top of a base film. The base film can be various types of plastic such as Polyimide (PI), Polycarbonite (PC), Polyethyleneterephtalate (PET), Polyethersulfone (PES), Polythylenenaphthalate (PEN), Fiber Reinforced Plastic (FRP), etc. The barrier coating is located on opposing surfaces in the base film, and organic or inorganic films can be used in order to maintain flexibility.

The plurality of LEDs are one type of display element that can be used by various embodiments; other embodiments can include a laser source with its beam diffused by a diffusing element, an organic light-emitting diode (OLED) utilizing some form of flexible plate, etc. In all embodiments, the display elements can generate a display area on a non-flat, yielding, and/or uneven surface.

An operation is executed disposed a plurality of touch sense electrodes on the flexible PCB such that they are interleaved (i.e., interspersed) between the plurality of LEDs to create a user touch interface at least partially overlapping the display area (shown as block 504). As discussed above, the electrodes can be uniform in size, or can vary in size. The control circuitry for the touch sense electrodes can allow for subsets of the touch sense electrodes (or even individual electrodes) to be controlled independently for efficient power management of the electrodes during run-time.

An operation is executed to place the flexible PCB in a forming mold (shown as block 506), and an operation is executed to fill the forming mold with a material configured to harden into an overmold housing (shown as block 508). The overmold housing is formed in a manner such that the LEDs are visible through the overmold housing, and the touch electrodes are capable of sensing user touch inputs through the overmold housing. The material of the overmold housing can comprise any plastic injectable materials such that one thermoplastic material is molded over another material to form one part. As discussed above, the display and user touch interface formed on the PCB does not include any glass surface, and does not necessarily utilize a flat, hard surface; thus, the display and user touch interface can withstand a variety of melt temperatures, mold temperatures, and packaging pressures used in various overmold processes.

An operation is executed to place a battery power supply into the overmold housing and couple the flexible PCB to a battery power supply (shown as block 510). The electronic components of the PCB, including the display and user touch interface, cannot be connected to power during the overmold process to prevent any damage to the components during the some operations used during the overmold process—e.g., exposure to water, dust, oil, or chemicals, movement, extreme temperatures, etc.

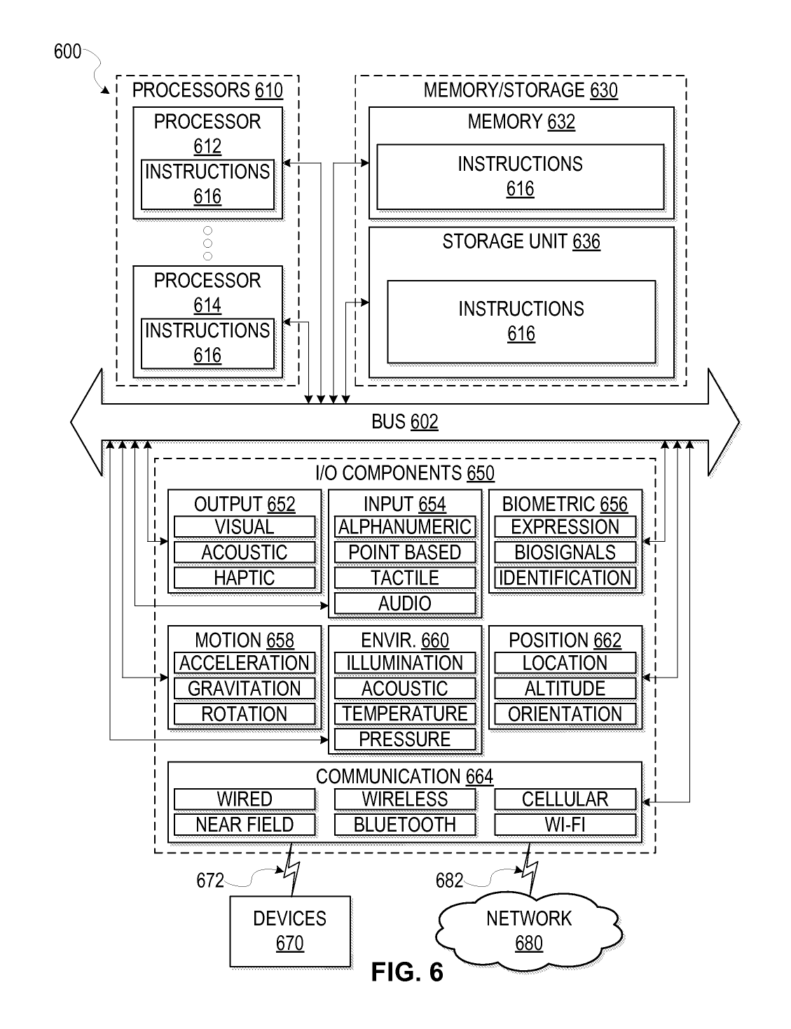

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example the instructions may cause the machine to execute the flow diagram of FIG. 3. Additionally, or alternatively, the instructions may implement the wearable computing device power management modules described above, and so forth. The instructions transform the general, non-programmed machine into a particular machine programmed to carry out the described and illustrated functions in the manner described. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 612 and processor 614 that may execute instructions 616. The term “processor” is intended to include a multi-core processor that may comprise two or more independent processors (sometimes referred to as “cores”) that may execute instructions contemporaneously. Although FIG. 6 shows multiple processors, the machine 600 may include a single processor with a single core, a single processor with multiple cores (e.g., a multi-core process), multiple processors with a single core, multiple processors with multiples cores, or any combination thereof.

The memory/storage 630 may include a memory 632, such as a main memory, or other memory storage, and a storage unit 636, both accessible to the processors 610 such as via the bus 602. The storage unit 636 and memory 632 store the instructions 616 embodying any one or more of the wearable computing device power management methodologies or functions described herein. The instructions 616 may also reside, completely or partially, within the memory 632, within the storage unit 636, within at least one of the processors 610 (e.g., within the processor's cache memory), or any suitable combination thereof, during execution thereof by the machine 600. Accordingly, the memory 632, the storage unit 636, and the memory of processors 610 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 616. The term “machine-readable medium” shall also be taken to include any medium, or combination of multiple media, that is capable of storing instructions (e.g., instructions 616) for execution by a machine (e.g., machine 600), such that the instructions, when executed by one or more processors of the machine 600 (e.g., processors 610), cause the machine 600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms. It will be appreciated that the I/O components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662 among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 662 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via coupling 682 and coupling 672 respectively. For example, the communication components 664 may include a network interface component or other suitable device to interface with the network 680. In further examples, communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a Universal Serial Bus (USB)).

Moreover, the communication components 664 may detect identifiers or include components operable to detect identifiers. For example, the communication components 664 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as, location via Internet Protocol (IP) geo-location, location via Wi-Fi® signal triangulation, location via detecting a NFC beacon signal that may indicate a particular location, and so forth.

In various example embodiments, one or more portions of the network 680 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network and the coupling 682 may be a Code Division Multiple Access (CDMA) connection, a Global System for Mobile communications (GSM) connection, or other type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., hypertext transfer protocol (HTTP)). Similarly, the instructions 616 may be transmitted or received using a transmission medium via the coupling 672 (e.g., a peer-to-peer coupling) to devices 670. The term “transmission medium” shall be taken to include any intangible medium that is capable of storing, encoding, or carrying instructions 616 for execution by the machine 600, and includes digital or analog communications signals or other intangible medium to facilitate communication of such software.

Although an embodiment has been described with reference to specific example embodiments, it will be evident that various modifications and changes can be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 67 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A wearable computing device comprising:
a printed circuit board (PCB);
a housing configured to be attached to a user, enclosed over the PCB, and including a display surface;
a plurality of electronic components disposed on the PCB and including a plurality of display components to generate display data visible through the display surface of the housing; and
a user input touch interface at least partially overlapping the display surface of the housing, the user input touch interface comprising:
an array of capacitive touch-sensitive electrode elements disposed on the PCB, wherein at least some of the electrode elements are interspersed on the PCB between two or more of the display components; and
sensing circuitry configured to detect changes in the array of capacitive touch-sensitive electrode elements.

2. The wearable computing device of claim 1, wherein the array of capacitive touch-sensitive electrode elements of the user input touch interface and the plurality of display components are disposed on a top surface of the PCB.

3. The wearable computing device of claim 1, wherein each of the array of capacitive touch-sensitive electrode elements of the user input touch interface are disposed under the display surface of the housing.

4. The wearable computing device of claim 1, wherein the housing is overmolded over the PCB.

5. The wearable computing device of claim 4, wherein the display surface of the housing comprises an at least semi-transparent overmold material.

6. The wearable computing device of claim 4, wherein the housing comprises a semi-opaque overmold material, and the display surface of the housing has a thickness configured to allow the display data from the plurality of display components to be visible through the housing.

7. The wearable computing device of claim 1, wherein the sensing circuitry of the user touch input interface is further configured to execute a plurality of operating modes, including a low-power operating mode to detect changes in a subset of the array of capacitive touch-sensitive electrode elements.

8. The wearable computing device of claim 7, wherein the array of capacitive touch-sensitive electrode elements of the user input touch interface comprises:
a first subset of electrodes operable during the low-power operating mode; and
a second subset of electrodes disabled during the low-power operating mode and operable during a second operating mode different than the low-power operating mode.

9. The wearable computing device of claim 8, wherein the first subset of electrodes is disabled during the second operating mode.

10. The wearable computing device of claim 9, wherein the first subset of electrodes includes an electrode surrounding the second subset of electrodes.

11. The wearable computing device of claim 1, wherein the plurality of electronic components further comprises:
a memory to store one or more applications; and
one or more processing units to execute the application(s) stored in the memory;
wherein at least one of a quantity of the electrodes of the user input touch interface or a scan rate of the electrodes of the user input touch interface is to be configured during execution of one of the application(s).

12. The wearable computing device of claim 1, wherein the housing comprises a flexible continuous band configured for wearing on a wrist of the user, and the PCB comprises a flexible PCB substantially conforming to the curved housing.

13. The wearable computing device of claim 1, wherein the housing comprises a clasp having an open position and a closed position for securing the housing on the user.

14. The wearable computing device of claim 1, further comprising:
one or more biometric sensors included in the housing for contacting a body part of the user to obtain biometric data of the user when the wearable computing device is worn by the user.

15. The wearable computing device of claim 1, wherein the housing comprises a curved housing, and the user input touch interface and the display surface are curved to substantially conform to the curved housing.

16. The wearable computing device of claim 1, wherein the plurality of display components comprise light emitting diodes (LEDs).

17. The wearable computing device of claim 1, wherein the plurality of electronic components further includes:
a wireless interface, including one or more antennas, to communicatively couple the wearable computing device to a second computing device,
wherein the user input touch interface is to operate as a user input for one or more applications executed via the second computing device.

18. A printed circuit board (PCB) comprising:
a plurality of electronic components including a plurality of display components disposed on a top surface of the PCB to generate display data; and
a user input touch interface comprising:
an array of capacitive touch-sensitive electrode elements disposed on the top surface of the PCB, wherein at least some of the electrode elements are interspersed on the PCB between two or more of the display components; and
sensing circuitry configured to detect changes in the array of capacitive touch-sensitive electrode elements.

19. The PCB of claim 18, wherein the array of capacitive touch-sensitive electrode elements of the user input touch interface comprises:
a first subset of electrodes operable during a first operating mode; and
a second subset of electrodes disabled during the first operating mode and operable during a second operating mode different than the first operating mode.

20. The PCB of claim 19, wherein the first subset of electrodes includes an electrode surrounding the second subset of electrodes.

21. The PCB of claim 18, wherein the PCB is formed from a flexible PCB material.

22. A method comprising:
disposing a plurality of electronic elements on a top surface of a flexible printed circuit board (PCB), including a plurality of light emitting diodes (LEDs) to create a display area;
interleaving a plurality of touch sense electrodes between the plurality of LEDs on the top surface of the PCB to create a user touch interface at least partially overlapping the display area;
placing the flexible PCB in a forming mold; and
filling the forming mold with a material configured to harden into an overmold housing, wherein the overmold housing is formed in a manner such that the LEDs of the display area are visible inputs through the material of the overmold housing, and the touch sense electrodes are capable of sensing user touch inputs through the material of the overmold housing.

23. The method of claim 22, further comprising:
placing a battery power supply in the overmold housing; and
electrically coupling the flexible PCB to the battery power supply.

24. The method of claim 21, wherein the overmold housing comprises a flexible continuous band for wearing on a wrist of a user.

25. The method of claim 21, wherein the plurality of touch sense electrodes comprises a first touch sense electrode surrounding a plurality of other touch sense electrodes.
